(19) United States
(12) Patent Application Publication
(10) Pub. No.: US 2017/0017632 A1
(43) Pub. Date: Jan. 19, 2017

(54) Methods and Systems of Annotating Local and Remote Display Screens

(71) Applicant: Rulgers, The State University of New Jersey, New Brunswick, NJ (US)

(72) Inventors: Darrin York, East Brunswick, NJ (US); Raship Shah, Edison, NJ (US); Swapnil Patel, Edison, NJ (US); Kar Lun Chun, Piscataway, NJ (US)

(21) Appl. No.: 15/123,890

(22) PCT Filed: Mar. 6, 2015
(86) PCT No.: PCT/US15/19164

§ 371 Date: Sep. 6, 2016

Related U.S. Application Data
(60) Provisional application No. 61/949,170, filed on Mar. 6, 2014.

(51) Int. Cl. G06F 17/24; G06F 3/01

(52) U.S. Cl. CPC G06F 17/241; G06F 3/017

(57) ABSTRACT

An annotation system may include a presentation electronic device in communication with an input device and a user interface, and a computer-readable storage medium in communication with the presentation electronic device. The computer-readable storage medium may include one or more programming instructions that, when executed, cause the presentation electronic device to identify one or more open windows that are displayed via the user interface, where each open window comprises underlying content, cause a glass pane window to be displayed in front of the identified open windows, such that the underlying content of one or more of the identified open windows is visible through the glass pane window, receive input from the input device, determine whether the received input comprises an annotation, and in response to determining that the received input is an annotation, cause a visual representation of the annotation to be displayed on the glass pane window.

### CROSS-REFERENCE TO RELATED APPLICATIONS

This patent document claims priority to U.S. provisional patent application No. 61/949,170, filed Mar. 6, 2014, the disclosure of which is fully incorporated by reference.

### BACKGROUND

Conventional annotation features in software packages commonly exist for use only within the same application. For example, a presentation application having an annotation feature that allows a user to write anywhere on the screen, but this functionality only works in presentation mode and only in the presentation application. Other display objects outside of the presentation application cannot be annotated.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, an annotation system may include a presentation electronic device in communication with an input device and a user interface, and a computer-readable storage medium in communication with the presentation electronic device. The computer-readable storage medium may include one or more programming instructions that, when executed, cause the presentation electronic device to identify one or more open windows that are displayed via the user interface, where each open window comprises underlying content, cause a glass pane window to be displayed in front of the identified open windows, such that the underlying content of one or more of the identified open windows is visible through the glass pane window, receive input from the input device, determine whether the received input comprises an annotation, and in response to determining that the received input is an annotation, cause a visual representation of the annotation to be displayed on the glass pane window.

Optionally, one or more programming instructions that, when executed, cause the presentation electronic device to identify one or more open windows may include one or more programming instructions that, when executed, cause the presentation electronic device to access a window log from one or more memory locations, where the window log comprises information pertaining to one or more open windows.

In an embodiment, one or more programming instructions that, when executed, cause the presentation electronic device to identify one or more open windows may include one or more programming instructions that, when executed, cause the presentation electronic device to identify a plurality of open windows wherein at least one open window in the plurality corresponds to a different application than a different window in the plurality.

In an embodiment, one or more programming instructions that, when executed, cause the presentation electronic device to cause a glass pane window to be displayed in front of the identified open windows may include one or more programming instructions that, when executed, cause the presentation electronic device to determine a z-index value associated with each open window, identify, from the determined z-index values, a highest z-index value, and assign the glass pane window a z-index value that is one unit higher than the highest z-index value.

In an embodiment, one or more programming instructions that, when executed, cause the presentation electronic device to cause a glass pane window to be displayed in front of the identified open windows may include one or more programming instructions that, when executed, cause the presentation electronic device to cause a glass pane window that is transparent to be displayed in front of the identified open windows.

In an embodiment, one or more programming instructions that, when executed, cause the presentation electronic device to receive input from the input device may include one or more programming instructions that, when executed, cause the presentation electronic device to receive input data that includes one or more of the following: data associated with one or more movements of the input device, position data associated with the one or more movements, duration information associated with one or more movements of the input device, and pressure information associated with one or more movements of the input device.

In an embodiment, one or more programming instructions that, when executed, cause the presentation electronic device to determine whether the received input may include an annotation comprise one or more programming instructions that, when executed, cause the presentation electronic device to identify a movement from the received input, where the movement represents a motion of the input device, identify a duration associated with the movement, and determine that the received input comprises an annotation in response to the duration exceeding a threshold value.

In an embodiment, one or more programming instructions that, when executed, cause the presentation electronic device to determine whether the received input includes an annotation may include one or more programming instructions that, when executed, cause the presentation electronic device to identify a movement from the received input, wherein the movement represents a motion of the input device, identify a duration associated with the movement, identify a normal click time value, identify a long click time value, determine whether the duration is greater than or equal to the normal click time value and less than or equal to the long click time value, in response to determining that the duration is greater than or equal to the normal click time value and less than or equal to the long click time value, determine whether the movement matches one or more motions, and in response to determining that the movement matches one or more motions, determine that the received input comprises an annotation.

In an embodiment, one or more programming instructions that, when executed, cause the presentation electronic device to receive input from the input device may include one or more programming instructions that, when executed, cause the presentation electronic device to receive input data comprising data associated with one or more movements of the input device, and coordinates of the user interface associated with each of the one or more movements. One or more programming instructions that, when executed, cause the presentation electronic device to cause a visual representation of the annotation to be displayed on the glass pane window may include one or more programming instructions that, when executed, cause the presentation electronic device to cause a visual representation of the one or more movements to be displayed by the glass pane windows at the associated coordinates on the user interface.

In an embodiment, one or more programming instructions that, when executed, cause the presentation electronic device to cause a visual representation of the annotation to be displayed on the glass pane window may include one or more programming instructions that, when executed, cause the presentation electronic device to cause a visual representation of the annotation to be displayed on the glass pane window such that the display of the annotation does not modify the underlying content of one or more of the open windows that are visible through the glass window pane.

In an embodiment, a computer-readable storage medium may include one or more programming instructions that, when executed, cause the presentation electronic device to capture one or more of the following data: one or more screen captures of the user interface, where each screen capture comprises one or more of the open windows, at least a portion of underlying content of the one or more open windows, and the glass pane window, audio from an environment in vicinity of the presentation electronic device, and video from the environment in vicinity of the presentation electronic device.

In an embodiment, a computer-readable storage medium may include one or more programming instructions that, when executed, cause a presentation electronic device to process captured data to generate one or more audio/video streams.

In an embodiment, a computer-readable storage medium may include one or more programming instructions that, when executed, cause a presentation electronic device to send generated audio/video streams to a video electronic device for broadcast to one or more viewer electronic devices.

In an embodiment, a method of annotating one or more windows may include identifying one or more open windows that are displayed via a user interface of a presentation electronic device, where each open window comprises underlying content, causing, by the presentation electronic device, a glass pane window to be displayed in front of the identified open windows, such that the underlying content of one or more of the identified open windows is visible through the glass pane window, receiving, by the presentation electronic device, input from an input device, determining whether the received input comprises an annotation, and in response to determining that the received input is an annotation, causing a visual representation of the annotation to be displayed on the glass pane window.

In an embodiment, identifying one or more open windows may include accessing a window log from one or more memory locations, where the window log includes information pertaining to one or more open windows.

In an embodiment, identifying one or more open windows may include identifying a plurality of open windows where at least one open window in the plurality corresponds to a different application than a different window in the plurality.

In an embodiment, causing a glass pane window to be displayed in front of the identified open windows may include determining a z-index value associated with each open window, identifying, from the determined z-index values, a highest z-index value, and assigning the glass pane window a z-index value that is one unit higher than the highest z-index value.

In an embodiment, causing a glass pane window to be displayed in front of the identified open windows may include causing a glass pane window that is transparent to be displayed in front of the identified open windows.

In an embodiment, receiving input from the input device may include receiving input data that includes one or more of the following: data associated with one or more movements of the input device, position data associated with the one or more movements, duration information associated with one or more movements of the input device, and pressure information associated with one or more movements of the input device.

In an embodiment, determining whether the received input includes an annotation may include identifying a movement from the received input, wherein the movement represents a motion of the input device, identifying a duration associated with the movement, and determining that the received input comprises an annotation in response to the duration exceeding a threshold value.

In an embodiment, determining whether the received input includes an annotation may include identifying a movement from the received input, where the movement represents a motion of the input device, identifying a duration associated with the movement, identifying a normal click time value, identifying a long click time value, determining whether the duration is greater than or equal to the normal click time value and less than or equal to the long click time value, in response to determining that the duration is greater than or equal to the normal click time value and less than or equal to the long click time value, determining whether the movement matches one or more motions, and in response to determining that the movement matches one or more motions, determining that the received input comprises an annotation.

In an embodiment, receiving input from the input device may include receiving input data that includes data associated with one or more movements of the input device, and coordinates of the user interface associated with each of the one or more movements. Causing a visual representation of the annotation to be displayed on the glass pane window may include causing a visual representation of the one or more movements to be displayed by the glass pane windows at the associated coordinates on the user interface.

In an embodiment, causing a visual representation of the annotation to be displayed on the glass pane window may include causing a visual representation of the annotation to be displayed on the glass pane window such that the display of the annotation does not modify the underlying content of one or more of the open windows that are visible through the glass window pane.

In an embodiment, a method of annotating one or more windows may include capturing one or more of the following data: one or more screen captures of the user interface, wherein each screen capture comprises one or more of the open windows, at least a portion of underlying content of the one or more open windows, and the glass pane window, audio from an environment in vicinity of the presentation electronic device, and video from the environment in vicinity of the presentation electronic device. In an embodiment, the method may include processing the captured data to generate one or more audio/video streams. The method may further include sending the generated audio/video streams to a video electronic device for broadcast to one or more viewer electronic devices.

### BRIEF DESCRIPTION OF THE DRAWINGS

FIG. 1 illustrates an example annotation system according to an embodiment.

FIG. 2 illustrates a flow chart of an example method of causing a glass pane window to be displayed by a presentation electronic device according to an embodiment.

FIG. 3 illustrates a method of annotating a glass pane window according to an embodiment.

FIGS. 4A and 4B illustrate example annotations according to various embodiments.

FIG. 5 illustrates an example method of capturing one or more annotations according to an embodiment.

FIG. 6 illustrates an example method of making one or more audio/video streams available to one or more viewer electronic devices according to an embodiment.

FIG. 7 illustrates a block diagram of example hardware that may be used to contain or implement program instructions according to an embodiment.

### DETAILED DESCRIPTION

The following terms shall have, for purposes of this application, the respective meanings set forth below:

An “annotation” refers to a visual representation of one or more movements. In an embodiment, an annotation may include information associated with at least a portion of underlying content of a window that is displayed relative to the underlying content via a glass pane window, but does not change the associated underlying content. Example annotations may include, without limitation, notes, comments, diagrams, formulas, equations, handwriting, shapes, symbols, graphics, images, videos, text and/or the like.

A “display window” or “window” refers to a graphical control element that includes a visual area having at least a portion of content. A window may display output of and/or allow input of one or more processes of one or more programs or applications. Example windows may belong to programs such as, for example, word processing applications, Portable Document Format (PDF) applications, presentation applications, video applications, audio applications, spreadsheet applications, three-dimensional modeling applications, graphic or image applications, websites, social media feeds and/or the like.

An “electronic device,” a “processor,” or a “computing device” refers to a device that includes a processor and non-transitory, computer-readable storage medium. The memory may contain programming instructions that, when executed by the processor, cause the electronic device to perform one or more operations according to the programming instructions. Examples of electronic devices include, without limitation, personal computers, servers, mainframes, gaming systems, televisions, and portable electronic devices such as smartphones, personal digital assistants, cameras, tablet computers, laptop computers, media players and the like. When used in the claims, reference to “an electronic device,” “processor,” or “computing device” may include a single device, or it may refer to any number of devices having one or more processors that communicate with each other and share data and/or instructions to perform the claimed steps. When used in the claims, reference to “memory” or “computer-readable storage medium” may include a single memory device or medium, or it may refer to any number of memory devices or computer-readable storage media.

A “glass pane window” refers to a transparent, partially transparent and/or substantially transparent window that is displayed via a user interface in front of one or more windows.

An “input device” refers to a device used to provide information or data to an electronic device. Example input devices include, without limitation, a mouse, a joystick, a touch screen, a remote control, a pointing device, a stylus pen, a video input device, an audio input device, fingers (with respect to a touch screen or similar device), a motion controller such as one that accepts hand and/or finger motions as input and/or the like.

A “movement” refers to data or information associated with one or more motions of an input device. The data may include, without limitation, positional data, pressure data and/or duration data. Example movements may include, without limitation, one or more gestures, strokes and/or other movements that are made by one or more input devices.

A “recording device” refers to a device that is capable of capturing or recording audio, video, images, graphics, or other content or materials. Examples of a recording device may include, without limitation, a camera, a web camera, a microphone and/or the like.

A “screen capture” refers to an image or other recordation of one or more windows, underlying content of one or more windows, a glass pane window, one or more annotations and/or other content displayed via a user interface according to an embodiment.

“Underlying content” refers to content of one or more open windows that are displayed on a user interface and are not a glass pane window. For example, an open window may include a playing video which may be considered underlying content. Similarly, a word processing window may include typed text which may be considered underlying content. Additional and/or alternate underlying content may be used within the scope of this disclosure.

A “user interface” refers to a device by which one or more windows are displayed. Example user interfaces may include, without limitation, a monitor screen, a tablet screen, a mobile device screen, a television, or any other screen or display.

The methods and systems described in this disclosure pertain to a glass pane window that is displayed in front of one or more display windows that are visible via a user interface of an electronic device. A glass pane window may allow a user to annotate content of any display window displayed behind the glass pane window regardless of the type of content of the window, the type of window and/or the like. The described system may also capture such annotations and convert them into one or more video streams which may be presented to or made accessible to one or more remote viewers.

One example implementation of the methods and systems described in this disclosure is an education tool that may be used in a virtual recitation class. The described system may allow an instructor to work problems or make other presentations on the instructor's electronic device such as, for example, as part of a virtual or non-virtual lecture, recitation, lab, office hours, one-on-one tutoring, mentoring sessions and/or the like. These presentations may be recorded and broadcast in substantially real time to students in the class. In certain embodiments, presentations may be stored and accessed by viewers at a later time. Although certain methods and systems may be described in terms of an educational context, it is understood that the described methods and systems may be applied in other contexts such as, for example, as part of business presentations or other instructional or collaborative efforts.

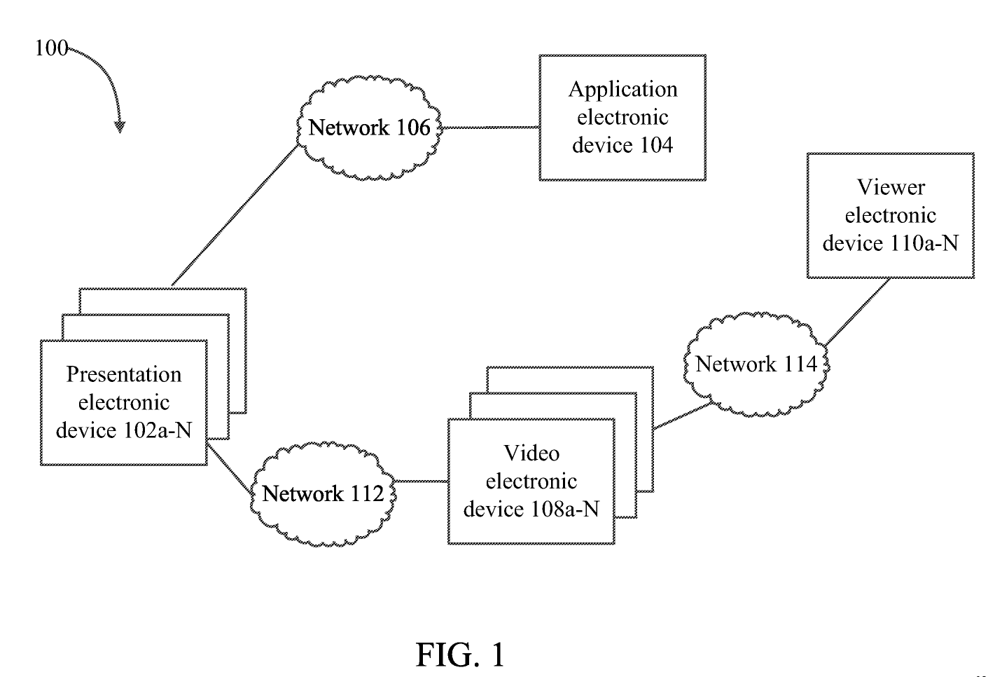

FIG. 1 illustrates an example annotation system according to an embodiment. As illustrated by FIG. 1, the system 100 may include one or more presentation electronic devices 102a-N in communication with an application electronic device 104 via one or more communication networks 106. A communication network 106 may be a local area network (LAN), a wide area network (WAN), a mobile or cellular communication network, an extranet, an intranet, the Internet and/or the like.

In an embodiment, a presentation electronic device 102a-N may annotate underlying content of one or more display windows via a glass pane application. A presentation electronic device 102a-N may access a glass pane application from an application electronic device 104. For instance, a glass pane application may be stored on an application electronic device 104. A presentation electronic device 102a-N may download a glass pane application from an application electronic device 104, and may install the glass pane on the presentation electronic device. In another embodiment, a presentation electronic device may 102a-N may access a glass pane application from an application electronic device 104 without downloading or installing the application.

In various embodiments, a presentation electronic device 102a-N may include and/or be in communication with a user interface, one or more input devices, one or more pressure sensors one or more computer-readable storage media and/or the like.

In an embodiment, a video electronic device 108a-N may receive one or more video packets from a presentation electronic device 102a-N via a communication network 112. A communication network 112 may be a local area network (LAN), a wide area network (WAN), a mobile or cellular communication network, an extranet, an intranet, the Internet and/or the like. A video electronic device 108a-N may transmit one or more videos or video portions to one or more viewer electronic devices 110a-N via a communication network 114, where they may be viewed. In an embodiment, one or more viewer electronic devices 110a-N may be located remotely from a video electronic device 108a-N and a presentation electronic device 102a-N. A communication network 114 may be a local area network (LAN), a wide area network (WAN), a mobile or cellular communication network, an extranet, an intranet, the Internet and/or the like.

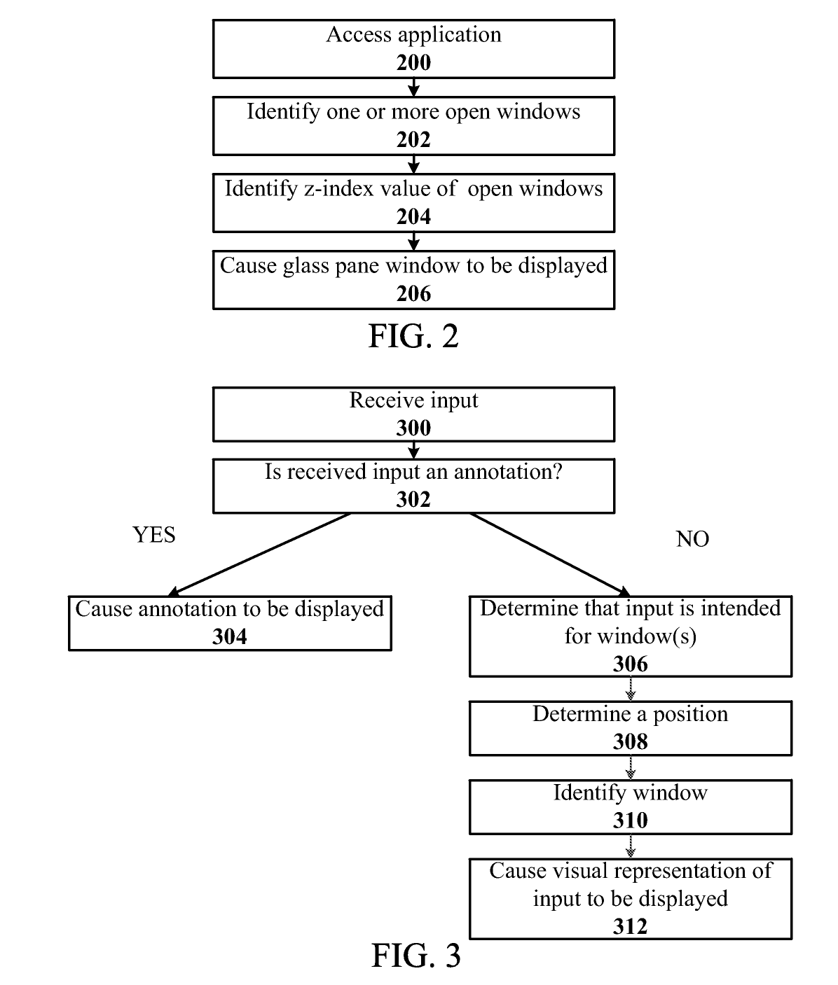

FIG. 2 illustrates a flow chart of an example method of causing a glass pane window to be displayed by a presentation electronic device according to an embodiment. A glass pane may be a transparent, a partially transparent, or a substantially transparent window that may be displayed via a user interface of a presentation electronic device. A glass pane window may be displayed in front of one or more other windows displayed via a user interface. As such, underlying content of one or more windows may be visible through the glass pane window. In an embodiment, a desktop or other background of a user interface may be considered as a window. As such, a user may annotate a desktop or other background using a glass pane window.

As illustrated by FIG. 2, a presentation electronic device may access 200 a glass pane application. A presentation electronic device may access 200 a glass pane application via an application electronic device. In an embodiment, a presentation electronic device may access 200 a glass pane application by downloading and installing a glass pane application from an application electronic device. In other embodiments, a presentation electronic device may access 200 a glass pane application by accessing a glass pane application that is stored by an application electronic device via a communication network.

In an embodiment, a presentation electronic device may identify 202 one or more open windows that are displayed on a user interface of the presentation electronic device. When a window is opened on an electronic device, the device may log information associated with the window such as, for example, an application that launched the window, a position of the window on a user interface, a z-index of the window, one or more dimensions of the window such as, for example, a width and/or height of the window, a size of the window, a relative position of the window with respect to one or more other windows, information about one or more windows that the window overlaps and/or is overlapped by, and/or the like. In an embodiment, a z-index may represent or indicate a stack order of one or more windows displayed by a user interface. A window with a greater z-index value may be displayed in front of a window with a lower z-index value.

A presentation electronic device may identify 202 one or more open windows by accessing information pertaining to one or more windows that are open on the electronic device. In an embodiment, information pertaining to one or more open windows may be stored in a window log. A window log may be a memory location, such as, for example, a database, a table, a list and/or the like, of a presentation electronic device. In another embodiment, a window log may be a memory location that is accessible by a presentation electronic device. For instance, a presentation electronic device may access a window log database of the presentation electronic device to identify 202 one or more open windows.

A presentation electronic device may identify 204 a z-index value of one or more of the identified open windows. For example, a presentation electronic device may access a window log database or other memory location to identify the z-index of one or more open windows. A presentation electronic device may cause 206 a glass pane window to be displayed on a user interface. A presentation electronic device may cause 206 a glass pane window having a size that corresponds to a monitor size and/or a monitor resolution of the user interface. A presentation electronic device may cause 206 a glass pane window to be displayed in front of all of the other open windows such that the underlying content of one or more windows may be visible through a glass pane while maintaining the z-index of the open windows. For example, a presentation electronic device may identify a highest z-index value of the open windows, and may assign a glass pane window a z-index value that is one unit higher than the highest z-index value.

In an embodiment, a presentation electronic device may track the status of one or more open windows, and may maintain the state of the glass pane window relative to the open windows. For example, if a user opens a new window that has a higher z-index value than a glass pane window, a presentation electronic device may assign the z-index value of the glass pane window to the newly opened window, and may increment the z-index value of the glass pane window by one unit.

In an embodiment, one or more open windows may correspond to an application or program that differs from an application or program of one or more other open windows. For instance, three open windows may be displayed. Two of the open windows may be word processing windows, while the other open window may be a video application window. As another example, one window may correspond to a presentation application, one window may correspond to a PDF application, and the last window may correspond to a webpage. Additional and/or alternate combinations may be used within the scope of this disclosure.

In an embodiment, a presentation electronic device may cause 206 a glass pane window to be displayed on a user interface of an electronic device when the glass pane application is in an active state. For example, a user may turn a glass pane application on (active state) or off (inactive state) by making one or more selections such as, for example, selecting a button, a selection from a drop down menu, and/or changing one or more other settings associated with a glass pane application. In an active state, a glass pane window may be displayed in front of one or more open windows and may be capable of being annotated by a user. In an inactive state, a glass pane window may not be displayed and/or may not be capable of being annotated by a user.

In various embodiments, a presentation electronic device may cause 206 a glass pane window to be displayed on a user interface of an electronic device with respect to certain windows such as, for example, one or more windows of certain applications or programs. For instance, a user may configure a glass pane application so that a glass pane window is only displayed in front of specified windows. If a user closes those specified windows, the glass pane window may be automatically deactivated. Similarly, if a window is opened with a higher z-index than a specified window having a previously highest z-index, the glass pane window may be automatically deactivated.

In an embodiment, a presentation electronic device may cause 206 a glass pane window to be displayed in response to receiving a selection or other indication that a glass pane application is to be executed. For instance, a presentation electronic device may cause a glass pane application to be executed in response to receiving a selection of an icon or other representation of a glass pane application from, for example, an input device of a presentation electronic device. In another embodiment, a presentation electronic device may cause a glass pane application to be executed by sending one or more instructions to an application electronic device, which may in turn cause a glass pane application to be executed on the presentation electronic device. In some embodiments, a glass pane application may be executed using a web browser. For example, a glass pane application may be implemented as a Java applet that may be embedded in a web browser.

FIG. 3 illustrates a method of annotating a glass pane window according to an embodiment. As illustrated by FIG. 3, a presentation electronic device may receive 300 input via an input device of a presentation electronic device. In certain embodiments, received input may include data pertaining to one or more movements that are made by one or more input devices of a presentation electronic device. This information may include, without limitation, position information associated with a movement or portion of a movement, a duration information associated with a movement or portion of a movement, pressure information associated with a movement or a portion of a movement and/or the like.

In an embodiment, position information may be position data of a movement or movement portion relative to a user interface. Position information may include one or more locations, coordinates and/or the like associated with at least a portion of a movement. Duration information may include information about a time period that a certain movement or movement occurred. Pressure information may include information about a pressure with which a movement or portion of movement is input. For instance, if a user uses a stylus pen or a finger as an input device, a presentation electronic device may capture a pressure with which the pen or finger is applied to a user interface or other medium. In certain embodiments, a pressure sensor of a presentation electronic device may capture at least a portion of pressure information associated with at least a portion of a movement.

In certain embodiments, a movement may mimic a writing movement such as, for example, a pencil or ink pen stroke. For instance, a user may use a stylus pen, a mouse, a finger and/or another instrument to create one or more movements. For example, long strokes may result in a thin line which may become thicker as the stroke velocity decreases. Arcs in a movement may be rendered with a crescent-like shaped variable width draw where the movement width may be highest at the mid-way point of the arc while decreasing as the arc is normalized into a lesser angle. In an embodiment, a presentation electronic device may apply an anti-aliasing algorithm and/or a feathering algorithm to data pertaining to a movement to produce a smoother, more natural looking rendering of the movement. Shape annotation with circular properties may also result in a varying stroke width depending on the change in the angle of stroke from one rendering point to the next, the change in velocity of the stroke, and/or the pressure data.

In various embodiments, a presentation electronic device may determine 302 whether received input is an annotation to be displayed on a glass pane window. An annotation may be an insertion of content, removal of content and/or modification of content on a glass pane relative to underlying content of one or more open windows. An annotation may be handwriting, one or more hand drawings, one or more shapes, colors, graphics, images, text, and/or the like. For instance, a user may use a mouse or stylus pen to circle a certain portion of a website. As another example, a user may use a finger to write one or more equations on a portable document format (PDF) application.

In another embodiment, an annotation may be a removal or deletion of content or a portion of content displayed on a glass pane window. As another example, an annotation may be a modification of content or a portion of content displayed on a glass pane window. Additional and/or alternate annotations may be used within the scope of this disclosure.

In an embodiment, although an annotation may be displayed via a glass pane window relative to underlying content of one or more windows, an annotation may not change, alter or otherwise modify the underlying content. For instance, if an annotation is a comment that is written on a glass pane window over an article displayed in a PDF window, the underlying content of the PDF article is not changed by display of the annotation.

In an embodiment, an electronic device may determine 302 whether received input is an annotation by analyzing one or more properties of the received input. For example, an electronic device may analyze a duration, a position, a coverage, a pressure, and/or other properties of received input to determine whether received input is an annotation that is intended to be displayed on a glass pane window. For example, if a duration of a movement exceeds a threshold value while a glass pane application is in an active state, an electronic device may determine that the input is an annotation. As another example, if a duration of a movement does not exceed a threshold value while a glass pane application is in an active state, a presentation electronic device may determine that the input is an annotation. As another example, a movement that varies in pressure may be determined to be an annotation. As yet another example, a movement that is not a click or a tap may be determined to be an annotation.

As another example, a movement that does not have a duration that matches a normal click time range or a long click time range may be determined to be annotation. In certain embodiments, a movement that does not have a duration between a normal click time and a long click time and does not mimic a predetermined or pre-established movement may be determined to be an annotation. Additional and/or alternate ways of determining whether a movement is an annotation may be used within the scope of this disclosure.

In various embodiments, one or more threshold values, normal click time values, and/or long click time values may be configured, set or modified by a user or administrator. In other embodiments, a presentation electronic device may determine one or more of a threshold value, a normal click time value and a long click time value based on historical input values received by the presentation electronic device. Additional and/or alternate determinations may be used within the scope of this disclosure.

In various embodiments, one or more threshold values, normal click time values, and/or long click time values may be stored in a memory location of a presentation electronic device or in a memory location that is accessible to a presentation electronic device. A presentation electronic device may identify one or more of these parameters by accessing such parameter values from their stored memory location(s).

In certain embodiments, a presentation electronic device may determine whether one or more movements are part of the same annotation or a different, unrelated annotation. A presentation electronic device may make this determination using position information associated with one or movements and/or time between received inputs. For instance, a presentation electronic device may receive input having a data point with coordinates (3,2) at time 0 seconds and a following data point at (7,0) at time 5 seconds. Given the distance between the two data points and the time between receipt of the two data points, a presentation electronic device may determine that the first data point belongs to one movement while the second data point belongs to a different movement.

In various embodiments, one or more threshold values or combinations of threshold values may be used by a presentation electronic device to make a determination as to whether one or more movements are part of the same annotation. For instance, data points received five seconds or more apart from one another may be determined to belong to different movements. Similarly, data points that are more than a certain distance apart from one another may be determined to belong to different movements. In some embodiments, a presentation electronic device may determine whether a data point overlaps the coordinates of any data point belonging to a former movement. If so, the presentation electronic device may determine that the data point is part of the former movement.

In response to determining 302 that received input is an annotation, a presentation electronic device may cause 304 the annotation to be displayed by the glass pane window. In an embodiment, a presentation electronic device may translate a movement included in received input into a visual depiction of the movement. In certain embodiments, received input may include position information associated with a movement or portion of a movement. Position information may include one or more coordinates of a user interface where a movement was made such as, for example, one or more x-y coordinates. A performance electronic device may cause a visual representation of an annotation to be displayed by a glass pane window displayed by a user interface at one or more positions that correspond to the position information of the received input.

For example, a user may circle a word of a word processing application displayed by a user interface of a presentation electronic device using a mouse. The presentation electronic device may receive input data from the mouse corresponding to the circular movement and the position of the circular movement on the user interface. The presentation electronic device may cause a circle corresponding to the circular movement at the position to be displayed by the glass pane window at a location representation to the position of the input data.

In an embodiment, a visual representation of a movement may be displayed in accordance with one or more format settings. A format setting may define one or more features of how an annotation is to be displayed. Example format settings may include, without limitation, a color, a style, a thickness or thinness, or other formatting option associated with a visual representation of an annotation. In an embodiment, a format setting may be specified by a user. For instance, a user may specify a color for an annotation.

In other embodiments, a presentation electronic device may automatically change a format setting. For example, a presentation electronic device may scan a user interface and identify one or more displayed colors of one or more displayed windows. The presentation electronic device may rank the colors from most common to least common, and may select the least common color as the annotation color. In other embodiments, the electronic device may select the most common color (or a different color) as the annotation color. In certain embodiments, a presentation electronic device may periodically scan a user interface to determine whether an annotation color conflicts with one or more colors of one or more underlying windows. If a presentation electronic device determines that an annotation color conflicts with a color of one or more underlying windows, a presentation electronic device may select a different color that does not conflict with one or more colors of one or more underlying windows.

In an embodiment, a presentation electronic device may cause one or more annotations to be displayed relative to a window regardless of the location of the window. For example, a presentation electronic device may cause an annotation to be displayed on a glass pane window relative to a window located behind the glass pane window. If a user subsequently moves the window such as, for example, by shrinking the window, enlarging the window, moving the location of the window, and/or the like, the annotation may maintain its position relative to the window. For example, a user may circle an icon on a web browser window. If the user subsequently moves the window to the right of the user interface, a presentation electronic device may cause the position of the circle annotation on the glass pane window to be moved toward the right of the user interface so that the circle is still displayed around the icon.

In various embodiments, a presentation electronic may maintain position information of one or more annotations relative to one or more windows and/or underlying content of one or more windows. For instance, a presentation electronic device may store coordinates or other location information pertaining to one or more annotations relative to one or more windows and/or underlying content of one or more windows. A presentation electronic device may track the location of one or more windows or underlying content of one or more windows changes, the presentation electronic device may automatically update the location of one or more corresponding annotations to maintain the position of the annotation relative to the window or content.

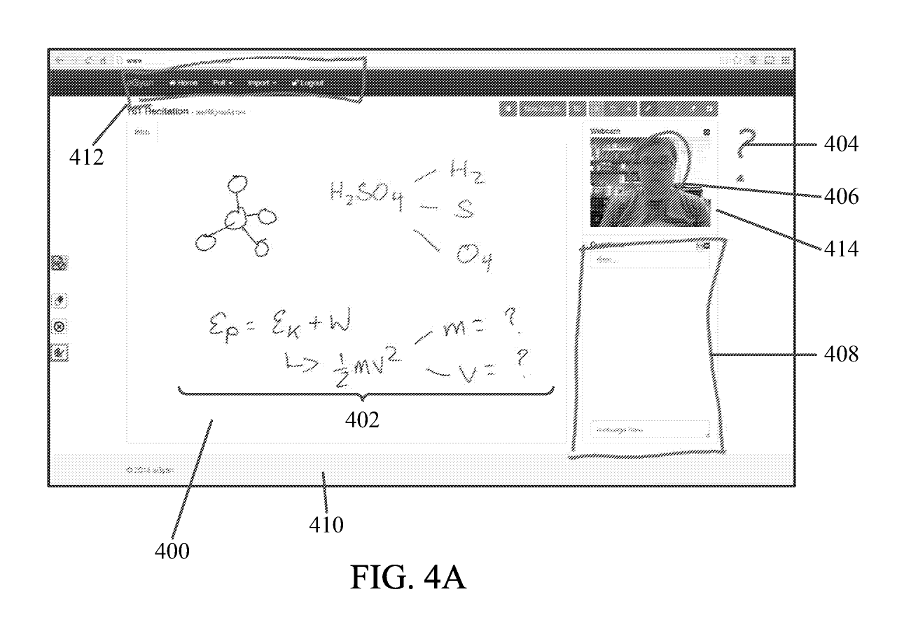

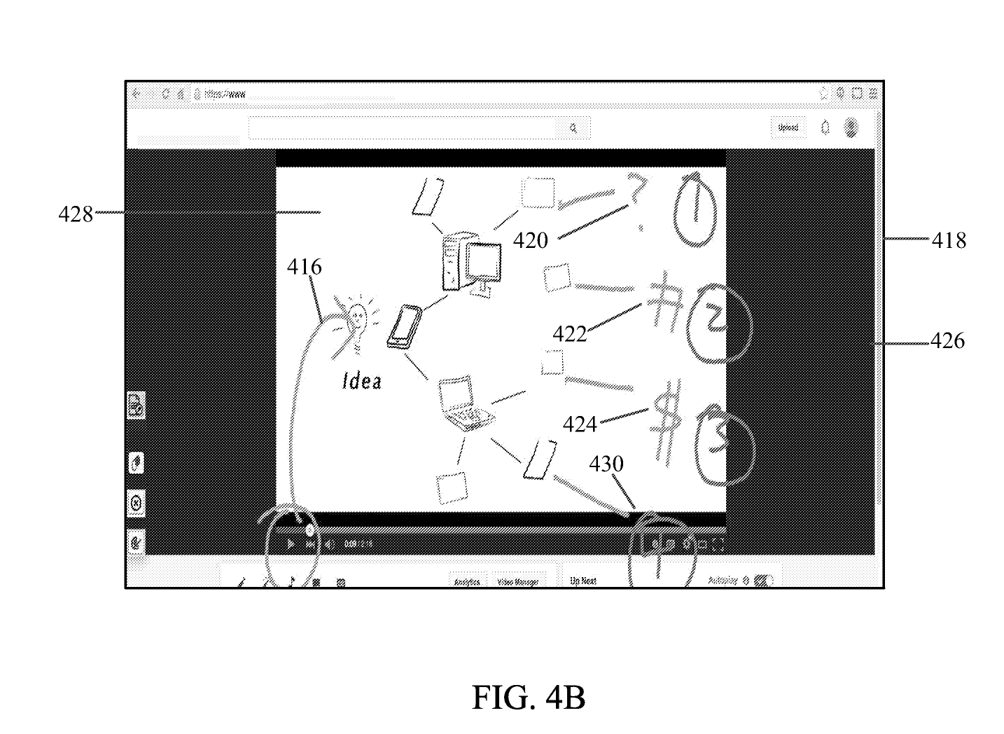

FIGS. 4A and 4B illustrate example annotations according to an embodiment. FIG. 4A illustrates a window 400 that is displaying underlying content 410 which includes handwritten equations, formulas and diagrams. Annotations displayed on a glass pane window 402 are represented by reference numbers 404, 406, 408 and 412. For example, as illustrated by FIG. 4A, a user has annotated the glass pane window 410 relative to window 414, which shows a web camera video as underlying content, by circling 406 a picture of the presenter. The annotation 406 (a hand-drawn circle) is displayed on glass pane window 410 that is displayed in front of the window 414.

FIG. 4B illustrates a window 426 that is displaying underlying content 428 which includes a running or playing video. Example annotations displayed on a glass pane window 418 are represented by reference numbers 420, 422, 424 and 430. For example, as illustrated by FIG. 4B, a user has annotated the glass pane window 418 relative to the window 426, by adding hand drawings and annotations 420, 422, 424 and 430. The annotations 420, 422, 424 and 430 are displayed on the glass pane window 418 that is displayed in front of window 426.

Referring back to FIG. 3, in response to determining 302 that received input is not an annotation, a presentation electronic device may determine 306 that the received input is intended for one or more windows located behind the glass pane window. In response to determining 306 that the received input is intended for one or more windows located behind the glass pane window, a presentation electronic device may determine 308 a position or positions associated with the received input. For example, the received input may include position information associated with the received input such as, for example, one or more coordinates of a user interface to which the received input corresponds. A presentation electronic device may identify 310 a window associated with the determined position or positions that has the highest z-index value. This ensures that received input is applied to the forefront most window behind a glass pane window.

In an embodiment, a presentation electronic device may cause 312 a visual representation of the received input to be displayed on the identified window at the determined position or positions. For instance, if the received input includes information associated with a single click of a mouse, a presentation electronic device may cause a cursor or other pointer to be displayed at the determined position or positions of the identified window. As another example, if received input includes information associated with a highlighting operation of certain text of a PDF window, a presentation electronic device may cause 312 the text to become highlighted on the PDF window that is being displayed behind a glass pane window.

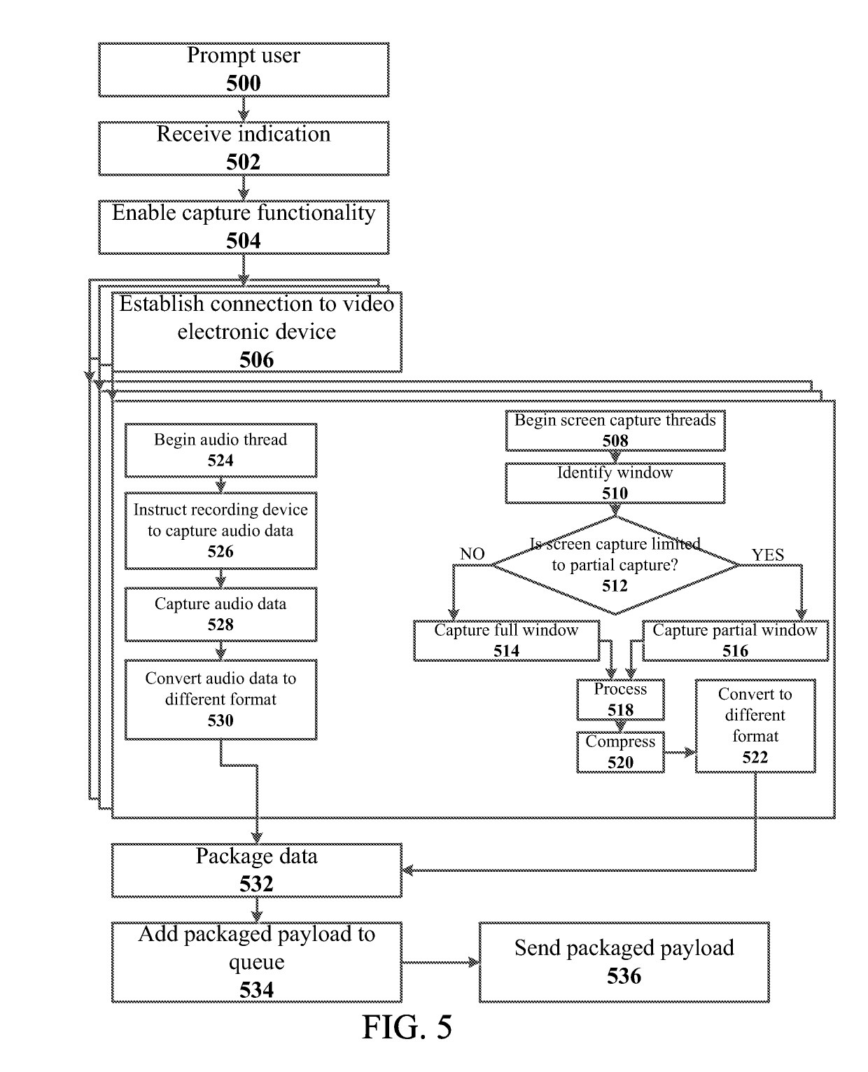

In certain embodiments, a presentation electronic device may capture one or more annotations, and may cause one or more of the annotations (and/or portions of underlying content) to be broadcast or otherwise provided to one or more viewer electronic devices. FIG. 5 illustrates an example method of capturing one or more annotations according to an embodiment. As illustrated by FIG. 5, a presentation electronic device may prompt 500 a user to enable capture functionality. A user may provide an indication of whether capture functionality should be enabled such as, for example, by selecting a button, a drop down menu, pressing a button or making another selection. In certain embodiments, a user may provide an indication of which recording device(s) should be enabled. A presentation electronic device may save these indications as one or more preferences which may automatically be used in one or more future capture sessions. For example, once a user identifies one or more preferred recording devices, these recording devices may be used in one or more future capture sessions until a user indicates otherwise.

A presentation electronic device may receive 502 the indication, and may, in response, enable 504 capture functionality according to the information or settings specified by a user.

In an embodiment, enabling 504 capture functionality may involve activating one or more recording devices of a presentation electronic device or one or more recording devices in communication with a presentation electronic device. A recording device may be a device capable of recording audio video such as, for example, a microphone, a web camera, a screen capture device and/or the like.

In an embodiment, a presentation electronic device may establish 506 one or more connections to a video electronic device. Each connection may start a thread combination for audio and/or video capture. Multiple connections may require multiple threads to achieve a simultaneous capture. As illustrated by FIG. 5, one or more of the threads may run a sequence of programs in a loop, where the loop delay and/or run rate is determined by a specified frame rate. In certain embodiments, a delay rate may represent a time for capture and post-processing of video stream packets.

In an embodiment, a presentation electronic device may begin 508 one or more screen capture threads. As illustrated by FIG. 5, a presentation electronic device may identify 510 a window or window portion to be captured. A presentation electronic device may identify 510 a window or window portion to be captured by receiving a selection of a particular window, windows or window portion(s) from a user. A presentation electronic device may identify 510 a window or window portion based on one or more indications or selections received from a user such as, for example, a selection, highlighting or other indication of a portion of an identified window. For instance, a user may have three windows open on a user interface of the user's presentation electronic device. However, the user may only want to capture the underlying content and annotations to one of those windows. A presentation electronic device may receive the selection, and may instruct one or more recording devices to only record the selected windows. In some embodiments, a user may select a glass pane window as a window that is to be recorded or not recorded. In other embodiments, a glass pane window may automatically be recorded, so no user instructions are necessary with respect to capture of the glass pane window.

In another embodiment, a presentation electronic device may identify 510 a window to be captured automatically by identifying one or more windows having a highest z-index value.

In an embodiment, a presentation electronic device may determine 512 whether a screen capture is limited to a partial capture of an identified window. For instance, a user may only want to capture the underlying content and annotations to a certain portion of a window. A user may indicate a selection of a certain portion of a window to be captured such as, for example, highlighting a specific section or portion, or otherwise selecting a specific section or portion of a window. A presentation electronic device may receive the selection, and may instruct one or more recording devices to only record the selected portion.

In an embodiment, a presentation electronic device may instruct a recording device to capture one or more identified windows and/or window portions. A recording device may in turn capture 514, 516 one or more screen captures of the identified window(s) and/or window portion(s). In an embodiment, a recording device may capture 514, 516 one or more screen captures periodically, such as, for example, between five frames per second and sixty frames per second. Additional and/or alternate intervals may be used within the scope of this disclosure.

In an embodiment, a recording device may capture 514, 516 video such as, for example, video of an environment surrounding or in the vicinity of the presentation electronic device. For example, an instructor who is giving a lecture using a presentation electronic device may want to record a video of himself giving the lecture so that one or more viewers can see him as part of the presentation. A web camera of the presentation electronic device (or in communication with the presentation electronic device) may record video of the instructor or other surroundings during the lecture and may display this video as part of a displayed window. As such, the video may be captured 514, 516 as part of a screen capture of the window.

Capture functionality may continue until a presentation electronic device receives an indication such as, for example, from a user via an input device, that one or more screen captures, video and/or audio components should no longer be captured. In an embodiment, a presentation electronic device may discontinue capture functionality in response to detecting that a user has navigated away from a window that is being captured.

As illustrated by FIG. 5, once one or more screen captures are performed, a presentation electronic device may process 518 the one or more screen captures. For example, a presentation electronic device may apply one or more algorithms or processes to the screen captures to sharpen areas where overlays and/or annotations are present, improve the quality or clarity of one or more screen captures and/or the like. Additional and/or alternate processes may be used within the scope of this disclosure.

In an embodiment, a presentation electronic device may compress 520 one or more screen captures. For example, a presentation electronic device may compress 520 one or more screen captures according to a configuration selected from a certain quality factor. For example, a presentation electronic device may compress 520 one or more screen captures according to a configuration selected from a quality factor between 0 (minimum) and 100 (maximum). As another example, a presentation electronic device may compress 520 one or more screen captures according to a configuration selected from a quality factor between a different range such as 45 and 100. Additional and/or alternate ranges may be used within the scope of this disclosure.

In certain embodiments, a presentation electronic device may compress 520 one or more captured images and/or video to create one or more different quality video streams. For instance, a presentation electronic device may create a low definition video stream, a standard definition video stream and/or a high definition video stream. As such, viewers may have a choice as to which quality stream to access depending on their network speed or connectivity. Additional and/or alternate quality video streams may be used within the scope of this disclosure.

In various embodiments, a presentation electronic device may convert 522 one or more compressed screen captures to a different format of data such as, for example, BGR data.

As illustrated by FIG. 5, a presentation electronic device may begin 524 one or more audio capture threads. A presentation electronic device may instruct 526 one or more recording devices to capture audio data such as, for example, data corresponding to audio of an environment surrounding or in the vicinity of the presentation electronic device. For example, an instructor who is giving a lecture using a presentation electronic device may be orally lecturing in combination with annotating certain materials on the instructor's presentation electronic device. In response to the instructions, a recording device may capture 528 at least a portion of audio data. For example, a microphone may record an audio lecture.

In an embodiment, a recording device may capture 528 audio data using pulse-code modulation (PCM) to generate PCM audio data. The generated PCM audio data may be converted 530 to a different format such as, for example, MP3 data.

In an embodiment, a presentation electronic device may package 532 one or more of converted audio data and converted compressed screen captures. For example, a presentation electronic device may use a packager such as, for instance, a Real Time Messaging Protocol video stream packager, to package 532 at least a portion of the converted PCM audio data and/or converted compressed screen captures. A presentation electronic device and/or packager may tag the converted PCM audio data and converted compressed screen captures as audio data or video data to create a packaged payload. For instance, a presentation electronic device and/or packager may tag metadata associated with such audio or video data. The created packaged payload may be added 534 to a send queue of the presentation electronic device. In an embodiment, a packaged payload may comprise one or more audio and/or one or more video streams.

In an embodiment, a presentation electronic device may send 536 the packaged payload(s) to a video electronic device. A video electronic device may store them in memory of the video electronic device or in memory in communication with or accessible to the video electronic device. In certain embodiments, if a user of a presentation electronic device desires, a copy of one or more of the packaged payload(s) may be stored in memory of the presentation electronic device or in memory in communication with the video electronic device.

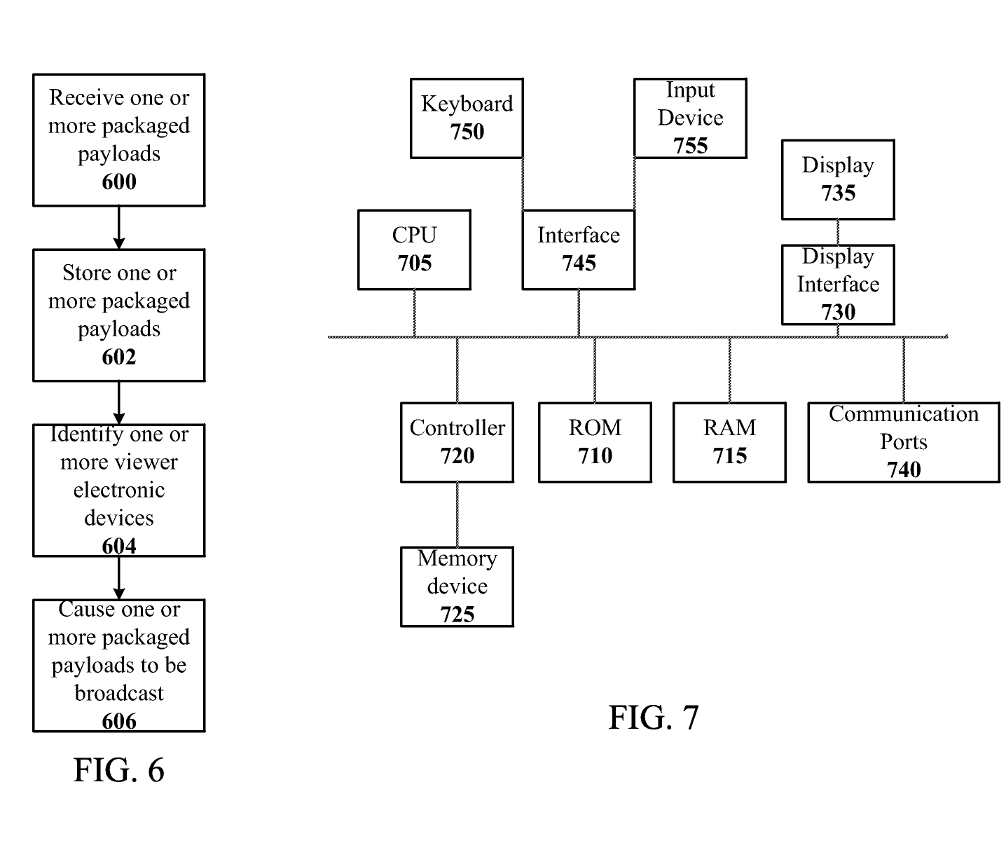

In various embodiments, a video electronic device may make one or more of the packaged payloads available to one or more viewer electronic devices. FIG. 6 illustrates an example method of making one or more packaged payloads available to one or more viewer electronic devices according to an embodiment. As illustrated by FIG. 6, a video electronic device may receive 600 one or more packaged payloads from a presentation electronic device. A video electronic device may store 602 one or more received packaged payloads in memory of the video electronic device or in memory in communication with or accessible to the video electronic device. In some embodiments, a presentation electronic device may store one or more packaged payloads in a particular memory location. For example, a video electronic device may store 602 one or more packaged payloads that are created by a certain user or a certain presentation electronic device in a dedicated memory location or locations associated with the user and/or the presentation electronic device. For instance, an instructor or other user may establish an account where one or more packaged payloads that are created by the user may be accessible. A video electronic device may store 602 all such received packaged payloads in a memory location(s) associated with the account.

A video electronic device may identify 604 one or more viewer electronic devices to which one or more packaged payloads are to be broadcast. A video electronic device may identify 604 one or more viewer electronic devices by determining one or more viewers who are subscribed to an audio/video feed associated with a particular user or instructor. For instance, students in a class may subscribe to an account, feed, or other content produced by a certain instructor of the class. Students may subscribe via a video electronic device or another electronic device in communication with the video electronic device. When the video electronic device receives one or more audio/video streams created by the instructor, the video electronic device may identify the viewer electronic devices associated with the subscribed students.

In another embodiment, a video electronic device may identify 604 one or more viewer electronic devices by receiving a request from a viewer electronic device. The request may include a request to access one or more stored packaged payloads. For example, a video electronic device may receive packaged payloads from a presentation electronic device associated with an instructor, and the video electronic device may store such packaged payloads. The video electronic device may receive a request from a student via a viewer electronic device to access the packaged payloads.

In an embodiment, a video electronic device may cause 606 one or more received packaged payloads to be broadcast or sent to one or more identified viewer electronic devices. In some embodiments, a video electronic device may cause 606 one or more received packaged payloads to be broadcast or sent in substantially real time upon receipt of the packaged payloads. In other embodiments, a video electronic device may cause 606 one more ore received packaged payloads to be broadcast or sent at some later time after receipt. For example, a video electronic device may cause 606 one or more received packaged payloads to be broadcast at a predefined time. As another example, a video electronic device may cause 606 one or more packaged payloads to be broadcast in response to receiving a request to access the packaged payloads by a viewer electronic device.

FIG. 7 depicts a block diagram of hardware that may be used to contain or implement program instructions. A bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is an example of a production device, computing device or processor as such terms are used within this disclosure. Read only memory (ROM) 710 and random access memory (RAM) 715 constitute examples of non-transitory computer-readable storage media.

A controller 720 interfaces with one or more optional non-transitory computer-readable storage media 725 to the system bus 700. These storage media 725 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 710 and/or the RAM 715. Optionally, the program instructions may be stored on a tangible, non-transitory computer-readable medium such as a compact disk, a digital disk, flash memory, a memory card, a USB drive, an optical disc storage medium and/or other recording medium.

An optional display interface 730 may permit information from the bus 700 to be displayed on the display 735 in audio, visual, graphic or alphanumeric format. Communication with external devices, such as a printing device, may occur using various communication ports 740. A communication port 740 may be attached to a communication network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. An annotation system, comprising:
a presentation electronic device in communication with an input device and a user interface; and
a computer-readable storage medium in communication with the presentation electronic device, wherein the computer-readable storage medium comprises one or more programming instructions that, when executed, cause the presentation electronic device to:
identify one or more open windows that are displayed via the user interface, wherein each open window comprises underlying content,
cause a glass pane window to be displayed in front of the identified open windows, such that the underlying content of one or more of the identified open windows is visible through the glass pane window,
receive input from the input device,
determine whether the received input comprises an annotation, and
in response to determining that the received input is an annotation, cause a visual representation of the annotation to be displayed on the glass pane window.

2. The annotation system of claim 1, wherein the one or more programming instructions that, when executed, cause the presentation electronic device to identify one or more open windows comprise one or more programming instructions that, when executed, cause the presentation electronic device to access a window log from one or more memory locations, wherein the window log comprises information pertaining to one or more open windows.

3. The annotation system of claim 1, wherein the one or more programming instructions that, when executed, cause the presentation electronic device to identify one or more open windows comprise one or more programming instructions that, when executed, cause the presentation electronic device to identify a plurality of open windows wherein at least one open window in the plurality corresponds to a different application than a different window in the plurality.

4. The annotation system of claim 1, wherein the one or more programming instructions that, when executed, cause the presentation electronic device to cause a glass pane window to be displayed in front of the identified open windows comprise one or more programming instructions that, when executed, cause the presentation electronic device to:
determine a z-index value associated with each open window;
identify, from the determined z-index values, a highest z-index value; and
assign the glass pane window a z-index value that is one unit higher than the highest z-index value.

5. The annotation system of claim 1, wherein the one or more programming instructions that, when executed, cause the presentation electronic device to cause a glass pane window to be displayed in front of the identified open windows comprise one or more programming instructions that, when executed, cause the presentation electronic device to cause a glass pane window that is transparent to be displayed in front of the identified open windows.

6. The annotation system of claim 1, wherein the one or more programming instructions that, when executed, cause the presentation electronic device to receive input from the input device comprise one or more programming instructions that, when executed, cause the presentation electronic device to receive input data comprising one or more of the following:
data associated with one or more movements of the input device;
position data associated with the one or more movements;
duration information associated with one or more movements of the input device; and
pressure information associated with one or more movements of the input device.

7. The annotation system of claim 1, wherein the one or more programming instructions that, when executed, cause the presentation electronic device to determine whether the received input comprises an annotation comprise one or more programming instructions that, when executed, cause the presentation electronic device to:
identify a movement from the received input, wherein the movement represents a motion of the input device;
identify a duration associated with the movement; and
determine that the received input comprises an annotation in response to the duration exceeding a threshold value.

8. The annotation system of claim 1, wherein the one or more programming instructions that, when executed, cause the presentation electronic device to determine whether the received input comprises an annotation comprise one or more programming instructions that, when executed, cause the presentation electronic device to:
identify a movement from the received input, wherein the movement represents a motion of the input device;
identify a duration associated with the movement;
identify a normal click time value;
identify a long click time value;
determine whether the duration is greater than or equal to the normal click time value and less than or equal to the long click time value;
in response to determining that the duration is greater than or equal to the normal click time value and less than or equal to the long click time value, determine whether the movement matches one or more motions; and
in response to determining that the movement matches one or more motions, determine that the received input comprises an annotation.

9. The annotation system of claim 1, wherein:
the one or more programming instructions that, when executed, cause the presentation electronic device to receive input from the input device comprise one or more programming instructions that, when executed, cause the presentation electronic device to receive input data comprising:
data associated with one or more movements of the input device, and
coordinates of the user interface associated with each of the one or more movements; and
the one or more programming instructions that, when executed, cause the presentation electronic device to cause a visual representation of the annotation to be displayed on the glass pane window comprise one or more programming instructions that, when executed, cause the presentation electronic device to cause a visual representation of the one or more movements to be displayed by the glass pane windows at the associated coordinates on the user interface.

10. The annotation system of claim 1, wherein the one or more programming instructions that, when executed, cause the presentation electronic device to cause a visual representation of the annotation to be displayed on the glass pane window comprise one or more programming instructions that, when executed, cause the presentation electronic device to cause a visual representation of the annotation to be displayed on the glass pane window such that the display of the annotation does not modify the underlying content of one or more of the open windows that are visible through the glass window pane.

11. The annotation system of claim 1, wherein the computer-readable storage medium further comprises one or more programming instructions that, when executed, cause the presentation electronic device to capture one or more of the following data:
one or more screen captures of the user interface, wherein each screen capture comprises one or more of the open windows, at least a portion of underlying content of the one or more open windows, and the glass pane window;
audio from an environment in vicinity of the presentation electronic device; and
video from the environment in vicinity of the presentation electronic device.

12. The annotation system of claim 11, wherein the computer-readable storage medium further comprises one or more programming instructions that, when executed, cause the presentation electronic device to process the captured data to generate one or more audio/video streams.

13. The annotation system of claim 12, wherein the computer-readable storage medium further comprises one or more programming instructions that, when executed, cause the presentation electronic device to send the generated audio/video streams to a video electronic device for broadcast to one or more viewer electronic devices.

14. A method of annotating one or more windows, the method comprising:
identifying one or more open windows that are displayed via a user interface of a presentation electronic device, wherein each open window comprises underlying content;
causing, by the presentation electronic device, a glass pane window to be displayed in front of the identified open windows, such that the underlying content of one or more of the identified open windows is visible through the glass pane window;
receiving, by the presentation electronic device, input from an input device;
determining whether the received input comprises an annotation; and
in response to determining that the received input is an annotation, causing a visual representation of the annotation to be displayed on the glass pane window.

15. The method of claim 14, wherein identifying one or more open windows comprises accessing a window log from one or more memory locations, wherein the window log comprises information pertaining to one or more open windows.

16. The method of claim 14, wherein identifying one or more open windows comprises identifying a plurality of open windows wherein at least one open window in the plurality corresponds to a different application than a different window in the plurality.

17. The method of claim 14, wherein causing a glass pane window to be displayed in front of the identified open windows comprises:
determining a z-index value associated with each open window;
identifying, from the determined z-index values, a highest z-index value; and
assigning the glass pane window a z-index value that is one unit higher than the highest z-index value.

18. The method of claim 14, wherein causing a glass pane window to be displayed in front of the identified open windows comprises causing a glass pane window that is transparent to be displayed in front of the identified open windows.

19. The method of claim 14, wherein receiving input from the input device comprises receiving input data comprising one or more of the following:
data associated with one or more movements of the input device;
position data associated with the one or more movements;
duration information associated with one or more movements of the input device; and
pressure information associated with one or more movements of the input device.

20. The method of claim 14, wherein determining whether the received input comprises an annotation comprises:
identifying a movement from the received input, wherein the movement represents a motion of the input device;
identifying a duration associated with the movement; and
determining that the received input comprises an annotation in response to the duration exceeding a threshold value.

21. The method of claim 14, wherein determining whether the received input comprises an annotation comprises:
identifying a movement from the received input, wherein the movement represents a motion of the input device;
identifying a duration associated with the movement;
identifying a normal click time value;
identifying a long click time value;
determining whether the duration is greater than or equal to the normal click time value and less than or equal to the long click time value;
in response to determining that the duration is greater than or equal to the normal click time value and less than or equal to the long click time value, determining whether the movement matches one or more motions; and
in response to determining that the movement matches one or more motions, determining that the received input comprises an annotation.

22. The method of claim 14, wherein:
receiving input from the input device comprises receiving input data comprising:
data associated with one or more movements of the input device, and
coordinates of the user interface associated with each of the one or more movements; and
causing a visual representation of the annotation to be displayed on the glass pane window comprises causing a visual representation of the one or more movements to be displayed by the glass pane windows at the associated coordinates on the user interface.

23. The method of claim 14, wherein causing a visual representation of the annotation to be displayed on the glass pane window comprises causing a visual representation of the annotation to be displayed on the glass pane window such that the display of the annotation does not modify the underlying content of one or more of the open windows that are visible through the glass window pane.

24. The method of claim 14, further comprising capturing one or more of the following data:
one or more screen captures of the user interface, wherein each screen capture comprises one or more of the open windows, at least a portion of underlying content of the one or more open windows, and the glass pane window;
audio from an environment in vicinity of the presentation electronic device; and
video from the environment in vicinity of the presentation electronic device.

25. The method of claim 24, further comprising processing the captured data to generate one or more audio/video streams.

26. The method of claim 25, further comprising sending the generated audio/video streams to a video electronic device for broadcast to one or more viewer electronic devices.
